(19) United States
(12) Patent Application Publication
(10) Pub. No.: US 2026/0136273 A1
(43) Pub. Date: May 14, 2026

(54) ELECTRONIC DEVICE AND METHOD FOR OPERATING ELECTRONIC DEVICE USING SATELLITE SERVICE TIME

(71) Applicant: SAMSUNG ELECTRONICS CO., LTD., Suwon-si (KR)

(72) Inventors: Injae SONG, Suwon-si (KR); Dongho KIM, Suwon-si (KR); Sangwon KIM, Suwon-si (KR); Kyunghoon LEE, Suwon-si (KR)

(21) Appl. No.: 19/445,880

(22) Filed: Jan. 12, 2026

Related U.S. Application Data
(63) Continuation of application No. PCT/KR2024/011189, filed on Jul. 30, 2024.

(30) Foreign Application Priority Data
Aug. 14, 2023 (KR) 10-2023-0106367
Sep. 26, 2023 (KR) 10-2023-0129485

(51) Int. Cl. H04W 48/16; H04W 4/14; H04W 4/90; H04W 48/18; H04W 84/04

(52) U.S. Cl. CPC H04W 48/16; H04W 48/18; H04W 4/14; H04W 4/90; H04W 84/042

(57) ABSTRACT

An electronic device includes a communication processor and a memory. The communication processor may be configured to cause the electronic device to: detect at least one satellite network based on the reception of at least one system information block (SIB); generate a PLMN list including at least one PLMN; determine the service time of each of a plurality of non-terrestrial wireless communication devices included in the PLMN list based on satellite data stored on the memory; and determine the priorities of the plurality of non-terrestrial wireless communication devices based on the determined service times, wherein the satellite data includes at least one of a mobile country code (MCC), a mobile network code (MNC), a mobile network code (TAI), a cell ID, and/or information about the service type of a service provided by the satellite network.

### CROSS-REFERENCE TO RELATED APPLICATIONS

This application is a continuation of International Application No. PCT/KR2024/011189 designating the United States, filed on Jul. 30, 2024, in the Korean Intellectual Property Receiving Office and claiming priority to Korean Patent Application Nos. 10-2023-0106367, filed on Aug. 14, 2023, and 10-2023-0129485, filed on Sep. 26, 2023, in the Korean Intellectual Property Office, the disclosures of each of which are incorporated by reference herein in their entireties.

### BACKGROUND

### Field

The disclosure relates to an electronic device, and to a method for operating an electronic device using a service time of, for example, non-terrestrial networks (NTNs).

### Description of Related Art

Standards for non-terrestrial networks have been defined since 3GPP Release 17. Satellite networks may operate at higher altitudes than existing terrestrial networks to provide wider communication coverage.

Cellular communication using non-terrestrial wireless communication devices may provide wider communication coverage and, therefore, has attracted attention for its potential to reduce shadow areas where communication services are unavailable.

However, the cellular communication using the non-terrestrial wireless communication devices may implement lower transmission and/or reception speeds than cellular communication using base stations, and thus, may be used to perform limited services (e.g., short message service (SMS) or voice call).

One of the features of the satellite networks is the difference in electric fields at cell boundaries. In the communication using the terrestrial networks, reference signal received power (RSRP) may decrease in proportion to a distance between a terminal and a base station. The RSRP may be referred to as an indicator indicating reception sensitivity of the terminal. The base station may determine when to perform cell reselection or handover (HO) based on the RSRP decreasing below a designated level.

However, the satellite network communications may not exhibit the difference in the RSRP between the cell center and the cell boundary. Unlike the terrestrial network communication, satellite base stations are relatively far from each terminal, so the change in RSRP strength due to the change in distance between the base station and each terminal may be small. Therefore, it may be difficult to perform RSRP-based reselection or handover (HO) as in the existing terrestrial networks.

### SUMMARY

An electronic device and method for operating an electronic device using a satellite service time according to the present disclosure may address the difficulty in determining whether the cell boundaries are present due to the features of the satellite base station.

The satellite services using the existing terrestrial networks may have difficulty providing satellite position information or service availability time, as the NTN standard has not yet defined. The electronic device and method for operating an electronic device using a satellite service time according to the present disclosure may address problems even when standards are not defined by determining satellite position information or service availability time using satellite information stored in the electronic device.

According to an example embodiment, an electronic device includes: at least one communication processor, comprising processing circuitry, and a memory, wherein at least one communication processor, individually and/or collectively, may be configured to cause the electronic device to: detect at least one satellite network based on a reception of at least one system information block (SIB), generate a public land mobile network (PLMN) list including at least one PLMN, determine service times of each of a plurality of non-terrestrial wireless communication devices included in the PLMN list based on satellite data stored in the memory, and determine priorities of the plurality of non-terrestrial wireless communication devices based on the determined service times, wherein the satellite data may include at least one of a mobile country code (MCC), a mobile network code (MNC), a mobile network code (TAI), a cell ID, and/or information about a service type of a service provided by the satellite network.

An electronic device and method for operating an electronic device using a satellite service time according to various embodiments may control the operation of the electronic device using the service type and service time of the satellite to be used based on the satellite information pre-stored in the electronic device.

An electronic device and method for operating an electronic device using a satellite service time according to various embodiments may improve the usability of satellite services by controlling priority selection and network transition timing for a plurality of public land mobile networks (PLMNs) on legacy systems (e.g., LTE) where satellite service time information is not explicitly transmitted.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments.

FIG. 2 is a block diagram illustrating an example configuration of the electronic device and a long-distance communication network environment according to various embodiments.

FIG. 3 is a diagram illustrating connection of the electronic device according to various embodiments.

FIG. 4 is a diagram illustrating a non-terrestrial network system according to various embodiments.

FIG. 5 is a diagram illustrating a difference in electric field at a cell boundary between a terrestrial network and a satellite network.

FIG. 6 is a block diagram illustrating an example configuration of the electronic device according to various embodiments.

FIG. 7 is a flowchart illustrating an example process of updating satellite-related data in the electronic device according to various embodiments.

FIGS. 8A and 8B are a flowchart and diagram illustrating an example process of determining priority of PLMN and selecting cells using a service type and service time of the PLMN on the electronic device according to various embodiments.

FIG. 9A is a flowchart illustrating an example process of performing a handover on the electronic device according to various embodiments.

FIG. 9B is a flowchart illustrating an example process of performing reselection on the electronic device according to various embodiments.

FIG. 10A is a flowchart illustrating an example in which service time-based measurement is performed in an idle state of the electronic device according to various embodiments.

FIG. 10B is a flowchart illustrating an example in which the service time-based measurement is performed in a connected state of the electronic device according to various embodiments.

### DETAILED DESCRIPTION

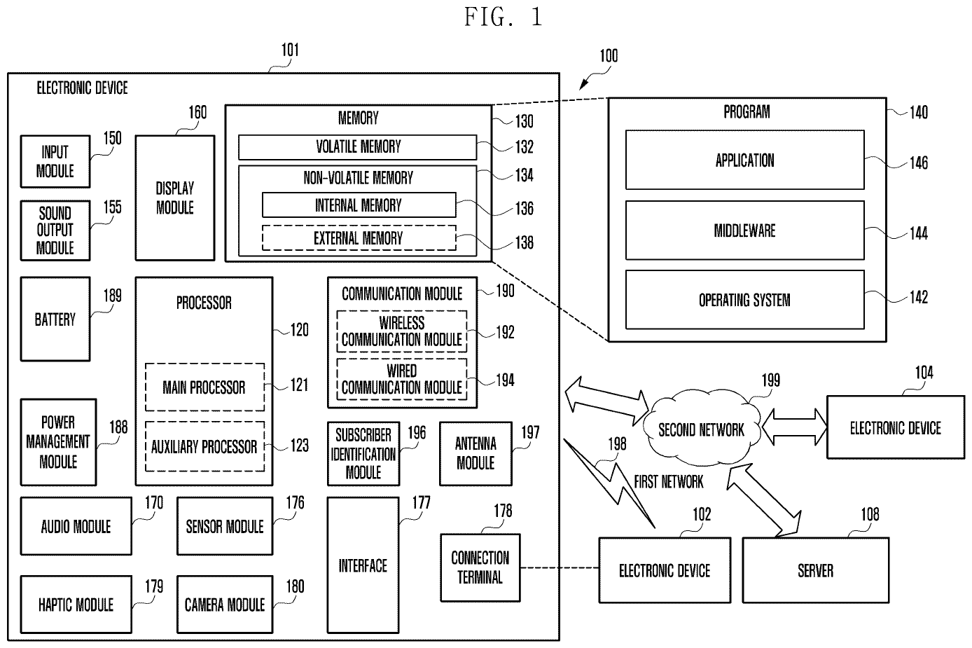

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

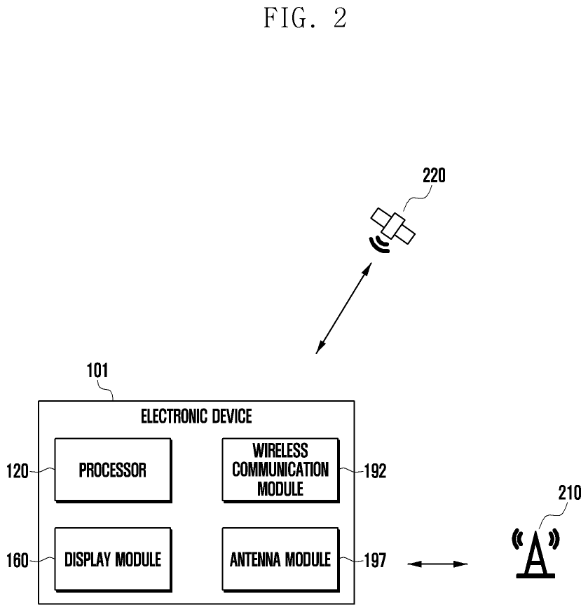

FIG. 2 is a block diagram illustrating an example configuration of an electronic device and a long-distance communication network environment according to various embodiments.

According to an embodiment, the electronic device 101 may transmit and/or receive data through a terrestrial network and/or non-terrestrial network. The electronic device 101 may be the same as the configuration of the electronic device illustrated in FIG. 1 or may include the configuration of the electronic device illustrated in FIG. 1.

According to an embodiment, a terrestrial network may refer to a network that can provide data communication through a terrestrial wireless communication device 310. For example, the terrestrial wireless communication device 310 may include a base station located on the ground (e.g., a base station fixed to the ground). The terrestrial wireless communication device 310 may support at least one communication scheme among various communication schemes that the electronic device 101 can support. For example, the terrestrial wireless communication device 310 may include an eNodeB or a gNodeB, but there is no limitation on its type.

According to an embodiment, a non-terrestrial network may refer to a network capable of providing data communication through at least one non-terrestrial wireless communication device 220. For example, the non-terrestrial wireless communication device 220 may include at least one of various communication devices such as a base station and repeater that are not located on the ground. For example, the non-terrestrial wireless communication device 220 may include a satellite and/or an unmanned aerial vehicle, but the type is not limited thereto. For example, satellites may include a low-earth orbit (LEO) satellite, a medium-earth orbit (MEO) satellite, a geostationary earth orbit (GEO) satellite, and/or a high elliptical orbit (HEO) satellite. For example, satellites may include mobile satellites and/or geostationary satellites.

According to an embodiment, the non-terrestrial wireless communication device 220 may support at least one of various wireless communication schemes. For example, the non-terrestrial wireless communication device 220 may support NR non-terrestrial network (NTN) defined by the 3rd generation partnership project (3GPP). Alternatively, the non-terrestrial wireless communication device 220 may support at least one of communication schemes based on various communication standards such as LTE, global system for mobile communications (GSM), and code-division multiple access (CDMA), but there is no limitation on the type.

According to an embodiment, the terrestrial network and the non-terrestrial network may be independent networks. The terrestrial network and the non-terrestrial network may be included in at least one network that is related to each other (e.g., a network provided by the same operator).

According to an embodiment, the electronic device 101 may perform wireless communication through a non-terrestrial network in case where the communication with a terrestrial network is not possible or is not smooth. In some cases, the electronic device 101 may perform wireless communication through a non-terrestrial network regardless of the communication status with the terrestrial network.

The processor 120 may, for example, execute software (e.g., the program 140) to control at least one other component (e.g., a hardware or software component) of the electronic device 101 connected to the processor 120, and may perform various data processing or operations. According to an embodiment, as at least a part of the data processing or operations, the processor 120 may store instructions or data received from another component (e.g., the sensor module 176 or the communication module 190) in the volatile memory 132, process the instructions or data stored in the volatile memory 132, and store result data in the non-volatile memory 134. According to an embodiment, the processor 120 may include a main processor 121 (e.g., a central processing unit or an application processor) or an auxiliary processor 123 (e.g., a graphics processing unit, a neural processing unit (NPU), an image signal processor, a sensor hub processor, or a communication processor) that can be operated independently of or together with the main processor 121. For example, when the electronic device 101 includes the main processor 121 and the auxiliary processor 123, the auxiliary processor 123 may be configured to use lower power than the main processor 121 or to be specialized for a designated function. The auxiliary processor 123 may be implemented separately from, or as a part of, the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may, for example, control at least some of the functions or states related to at least one component (e.g., the display module 160, the sensor module 176, or the communication module 190) among the components of the electronic device 101, on behalf of the main processor 121 while the main processor 121 is in an inactive (e.g., sleep) state, or together with the main processor 121 while the main processor 121 is in an active (e.g., application execution) state. According to an embodiment, the auxiliary processor 123 (e.g., an image signal processor or a communication processor) may be implemented as a part of another functionally related component (e.g., the camera module 180 or the communication module 190).

The display module 160 may visually provide information to the outside (e.g., a user) of the electronic device 101. The display module 160 may include, for example, a display, a hologram device, or a projector and control circuitry for controlling the corresponding device. According to an embodiment, the display module 160 may include a touch sensor configured to detect a touch, or a pressure sensor configured to measure the intensity of force generated by the touch.

A UI related to a terrestrial network and/or a non-terrestrial network (e.g., a screen showing a connection state with a network, a screen showing a direction of a non-terrestrial network (e.g., a satellite)) may be displayed. The UI related to the terrestrial network and/or the non-terrestrial network is not limited thereto.

The UI indicating information related to the terrestrial network and/or the non-terrestrial network may include, for example, at least one of a network type (e.g., cellular communication (3G, 4G, 5G), short-range communication (e.g., BT, WIFI), satellite communication), a network service provider type (e.g., a satellite communication service provider (e.g., Iridium), an emergency service provider (ESP)), a network signal strength (e.g., Signal Strength Bars, RSSI, RSRP), a direction of a communication device (satellite) included in the network (e.g., orientation, elevation angle, azimuth angle), presence information, or a network communication state (e.g., idle, transmit, receive).

Services associated with the terrestrial network and/or the non-terrestrial network may include, for example, at least one of an emergency message transmission service (e.g., guidance information such as SOS service status information (e.g., an indication that SOS service provision is available), government office information, emergency contact information, pre-defined phrases for minimizing/reducing user text input, or a questionnaire method for rapidly conveying an emergency situation (e.g., accident type, injured area, medical information (e.g., age, gender, disease information, medication information))), a messaging service (e.g., SMS (small message service), MMS, RCS message), a voice call, a video call, a data communication service (e.g., various application information providing data communication including an internet browser app), a location sharing service (e.g., longitude/latitude coordinates, MAP information related to the location of the non-terrestrial communication device 220, navigation, street view), or a UI related to a dialer and/or an indicator.

Various UI examples are not limited to the mentioned examples and may be provided through other output devices (e.g., the sound output module 155 of FIG. 1).

According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication module). A corresponding communication module among these communication modules may communicate with an external electronic device 104 via a first network 198 (e.g., a short-range communication network such as Bluetooth, wireless fidelity (WiFi) direct, or infrared data association (IrDA)) or a second network 199 (e.g., a long-range communication network such as a legacy cellular network, a 5G network, a next-generation communication network, the Internet, or a computer network (e.g., LAN or WAN)). These various types of communication modules may be integrated into a single component (e.g., a single chip) or may be implemented as a plurality of components (e.g., a plurality of chips) separate from one another. The wireless communication module 192 may identify or authenticate the electronic device 101 within a communication network such as the first network 198 or the second network 199 using subscriber information (e.g., international mobile subscriber identity (IMSI)) stored in the subscriber identification module 196.

The wireless communication module 192 may support a 5G network after a 4G network and next-generation communication technology, for example, new radio (NR) access technology. The NR access technology may support high-speed transmission of high-capacity data (enhanced mobile broadband (eMBB)), minimization/reduction of terminal power and connection of multiple terminals (massive machine type communications (mMTC)), or high reliability and low latency (ultra-reliable and low-latency communications (URLLC)). The wireless communication module 192 may support a high-frequency band (e.g., a mmWave band) to achieve, for example, a high data transmission rate. The wireless communication module 192 may support various technologies for securing performance in a high-frequency band, such as beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for realizing eMBB, a loss coverage (e.g., 164 dB or less) for realizing mMTC, or a U-plane latency (e.g., 0.5 ms or less for each of downlink (DL) and uplink (UL), or a round trip of 1 ms or less) for realizing URLLC.

The wireless communication bands supported by the electronic device 101 may include a short-range wireless communication band (e.g., BT, Wifi), a terrestrial network (e.g., cellular network) communication band, and/or a non-terrestrial network band, but are not limited thereto.

The electronic device 101 may support a frequency band (e.g., n255, 256) related to non-terrestrial network wireless communication. The electronic device 101 may perform non-terrestrial network wireless communication using at least a part of a frequency band related to terrestrial network wireless communication.

The antenna module 197 may transmit a signal or power to the outside (e.g., an external electronic device) or receive a signal or power from the outside. According to an embodiment, the antenna module 197 may include an antenna including a radiator formed of a conductor or a conductive pattern formed on a substrate (e.g., a PCB). According to an embodiment, the antenna module 197 may include a plurality of antennas (e.g., an array antenna). In this case, at least one antenna suitable for a communication scheme used in a communication network, such as the first network 198 or the second network 199, may be selected from the plurality of antennas by, for example, the communication module 190. The signal or power may be transmitted or received between the communication module 190 and the external electronic device via the selected at least one antenna. According to certain embodiments, other components (e.g., a radio frequency integrated circuit (RFIC)) may be additionally formed as a part of the antenna module 197 aside from the radiator.

The electronic device 101 may perform wireless communication with a non-terrestrial network using at least one antenna among the plurality of antennas included in the antenna module 197. The at least one antenna supporting non-terrestrial wireless communication may include a dedicated antenna and/or a shared antenna. The dedicated antenna may include an antenna supporting the non-terrestrial network. The shared antenna may include an antenna supporting another type of network together with the non-terrestrial network. For example, the electronic device 101 may communicate with at least one satellite (e.g., a GNSS satellite, a satellite for emergency message service) using one non-terrestrial network dedicated antenna. For example, the shared antenna may include an antenna supporting a short-range communication network (e.g., a Bluetooth network, a Wifi network) and/or a terrestrial network (e.g., a long term evolution (LTE) network). The electronic device 101 may support the non-terrestrial network using a plurality of antennas among antennas supporting the terrestrial network.

Hereinafter, although a satellite is mainly mentioned as the non-terrestrial wireless communication device 220 in the present disclosure, and the satellite is mentioned as providing wireless communication based on a specific radio access technology (RAT) (e.g., LTE) or a specific function (e.g., a base station), those skilled in the art will readily understand that this is an example and the type thereof is not limited.

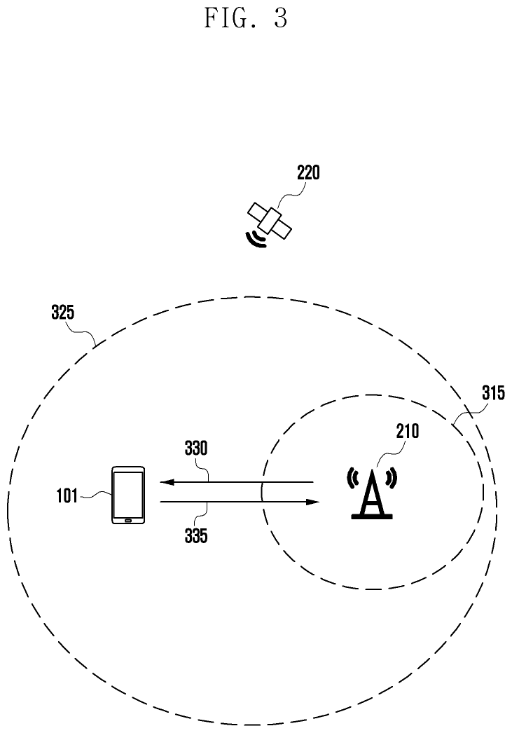

FIG. 3 is a diagram for explaining connection of an electronic device according to an embodiment.

According to an embodiment, the electronic device 101 may be located within a coverage 315 of the terrestrial wireless communication device 310 (hereinafter referred to as a terrestrial wireless communication coverage 315) and/or a coverage 325 of the non-terrestrial wireless communication device 220 (hereinafter referred to as a non-terrestrial wireless communication coverage 325). The non-terrestrial wireless communication coverage 325 may be relatively large (e.g., 50 times or more large) compared to the terrestrial wireless communication coverage 315. For example, the non-terrestrial wireless communication coverage 325 may cover an area that the coverage 315 of the terrestrial wireless communication device 310 does not cover, and accordingly, the electronic device 101 may perform communication even in an area where terrestrial wireless communication is not supported.

According to an embodiment, the electronic device 101 may perform cell scan within the terrestrial wireless communication coverage 315 and/or non-terrestrial wireless communication coverage 325. As a result of performing a cell scan, the electronic device 101 may identify the cell provided by the terrestrial wireless communication device 310 and/or cell provided by the non-terrestrial wireless communication device 220. In case where there is a cell that satisfies a cell selection condition, the electronic device 101 may perform at least some of the operations for connecting to a network (e.g., a non-terrestrial network and/or terrestrial network). Here, connection to the network may include, for example, at least some of preceding operations for registration into the network (e.g., a camp-on, a connection procedure (e.g., a random access (RA) procedure)) and/or registration operations into the network (e.g., attach, registration), but is not limited thereto. In case where disconnection from the network is necessary (e.g., movement to another network), the electronic device 101 may perform at least some of disconnection operations. The disconnect operation from the network may include at least some of detach from the network, disconnection, and/or RLF declaration, but is not limited to the listed operations.

According to an embodiment, the electronic device 101 may perform at least some operations of cell scanning, disconnection from the network, and/or connection to the network according to movements 330 and 335.

According to an embodiment, in case where the electronic device 101 is located inside the terrestrial communication coverage 315 included in the non-terrestrial wireless communication coverage 325 or is located in a border area of the terrestrial communication coverage 315, the electronic device 101 may perform connection to a terrestrial network and/or non-terrestrial network based on a policy (e.g., priority policy) of the electronic device 101.

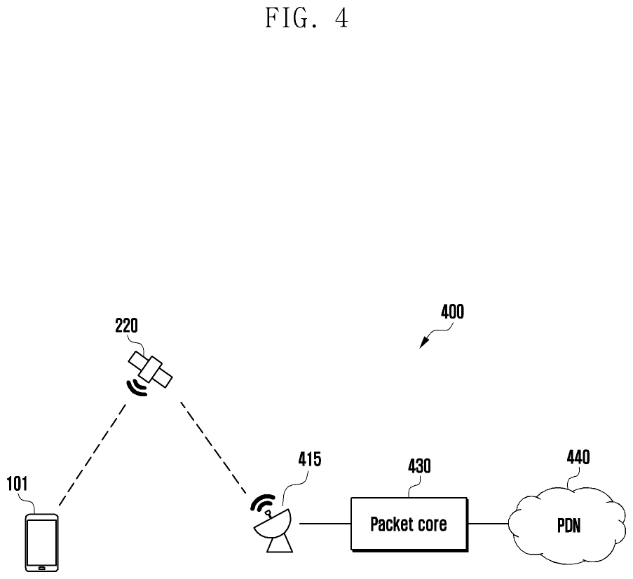

FIG. 4 is a diagram illustrating an example non-terrestrial network system 400 according to various embodiments.

With reference to FIG. 4, a non-terrestrial network system 400 according to an embodiment may include a non-terrestrial wireless communication device 220, a radio unit 415, and a packet core 430.

According to an embodiment, the non-terrestrial network system 400 may be implemented, for example, in a regenerative scheme. In case of being implemented in a regenerative scheme, at least one non-terrestrial wireless communication device 220 may include a base station (e.g., an eNode B). The non-terrestrial network system 400 may be implemented, for example, in a bent-pipe scheme. The bent-pipe scheme may include a passive relay scheme that performs frequency conversion and power amplification on a received signal. In case where the non-terrestrial network system 400 is implemented in the bent-pipe scheme, at least one non-terrestrial wireless communication device 220 may include a repeater that converts (e.g., amplifies) a signal and transmits it. The implementation scheme of the non-terrestrial network system 400 illustrated in FIG. 4 and the role of the non-terrestrial wireless communication device 220 are only examples and are not limited thereto.

According to an embodiment, the non-terrestrial wireless communication device 220 may include at least one satellite. For example, the non-terrestrial wireless communication device 220 may perform communication with the electronic device 101 using a terrestrial network (e.g., a cellular network) band and/or non-terrestrial network band. The terrestrial network band may be, for example, an operating band supported by long term evolution (LTE) and/or new radio (NR), but is not limited thereto. The non-terrestrial network bands may include, but are not limited to, bands defined by 3GPP (e.g., n255 bands and/or n256 bands).

According to an embodiment, at least one radio unit 415 may receive a signal from the non-terrestrial wireless communication device 220 and transmit it to the packet core 430. The radio unit 415 and the non-terrestrial wireless communication device 220 may perform communication using, for example, a non-terrestrial network band. The non-terrestrial network band may be different from the terrestrial network band, but may be set to be the same in some cases.

According to an embodiment, at least one packet core 430 may transmit and receive data associated with the electronic device 101 using the radio unit 415. Accordingly, the packet core 430 may process the data associated with the electronic device 101 and transmit it to a packet data network (PDN) 440 (e.g., the Internet). The packet core 415 may include, but is not limited to, at least some of, for example, an evolved packet core (EPC) and/or a 5G core (5GC). The packet core 430 may include the packet core associated with the operator of the non-terrestrial wireless communication device 220 and/or packet core associated with a mobile network operator (MNO). The packet core 430 may be additionally connected to a public switched telephone network (PSTN) (not shown) to transmit and receive the data associated with the electronic device 101.

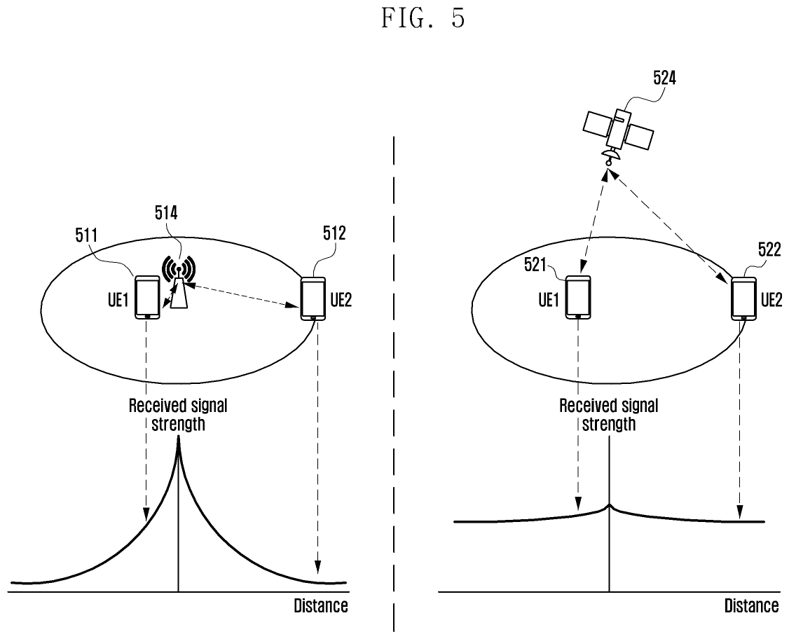

FIG. 5 is a diagram illustrating a difference in electric field at a cell boundary between a terrestrial network and a satellite network.

One of the features of the satellite networks is the difference in electric fields at cell boundaries. In the case of communication using a terrestrial network (TN) illustrated on the left with a boundary line as criteria, as a distance between terminals 511 and 512 and a base station 514 increases, a reference signal received power (RSRP) level measured by the terminal may decrease relatively rapidly. The RSRP may be referred to as an indicator indicating reception sensitivity of the terminal. The base station 514 may determine whether to perform cell reselection or handover (HO) based on the RSRP decreasing less than or equal to (or below) a designated level.

In the case of communication using a satellite network (non-terrestrial network (NTN)) illustrated on the right with the boundary line as the criteria, there may not be a large difference between the RSRP of a signal, which is transmitted by a satellite base station 524, measured by a terminal 521 in an area close to a cell center and the RSRP of the signal, which is transmitted by the satellite base station 524, measured by a terminal 522 in an area close to the periphery of a cell. That is, in the case of communication using the satellite network (NTN) illustrated in FIG. 5, as the distance between the terminals 511 and 512 and the satellite base station 524 increases, the RSRP level measured by the terminal may decrease relatively gradually. The above phenomenon may be because the distance between the satellite base station 524 and the terminals 511 and 512 is relatively large compared to the size (or distance) of the cell corresponding to the satellite base station 524. That is, the satellite base station 524 may have difficulty performing the reselection or handover of the cell based on the RSRP of the signal measured by the terminals 511 and 512.

The standard (e.g., 3GPP Rel. 17 NR-NTN) defines system information block (SIB) 19 as including relevant information such as a service time (e.g., t-service time) for satellite services. The terminals 511 and 512 may use SIB 19 to acquire information about the service time for satellite services and perform necessary operations.

Given primary orbital information of the satellite, the terminals 511 and 512 may calculate the position and movement path of the satellite and derive satellite coverage based on the calculated position and movement path. In other words, the terminals 511 and 512 may determine the satellite service time by calculating the current position of the satellite based on the satellite position information and identifying the current position of the terminal.

Depending on the features of the satellite network mentioned in FIG. 5, it may be necessary to determine whether the cell boundaries are present in a manner different from that of the existing terrestrial network systems. The standard defines a method for transmitting satellite position information or service availability time in various manners to determine whether the cell boundaries are present. However, the method for transmitting satellite position information or service availability time is defined by the Non-Terrestrial Networks (NTN) standard, and service provider networks should comply with this standard for such transmission to be possible. Therefore, it is difficult for the existing terrestrial network-based systems to support the transmission of the satellite position information and service availability time. For example, in the case of satellite services that many operators are currently preparing using the existing terrestrial networks, it may be difficult to acquire the satellite position information or service availability time in the same manner as the standard.

Services based on legacy systems (e.g., LTE) that use artificial satellites may use low earth orbit (LEO) satellites to interwork with the terrestrial networks and provide services. The LEO may refer to the artificial satellite orbit from the Earth's surface to an altitude of 2,000 km. Providing the satellite services using the LEO satellites may result in shorter service time. To address these disadvantages of the LEO satellites, the electronic device may provide communication services while changing base stations among a plurality of satellites. However, the existing communication systems (e.g., LTE) defined assuming communication with a fixed base station may not reflect the features of the satellite networks that change the base station.

The electronic device and method for operating an electronic device using a satellite service time according to the disclosure may control the operation of the electronic device using the service type and service time of the satellite to be used based on the satellite information pre-stored in the electronic device.

The electronic device and method for operating an electronic device using a satellite service time according to the disclosure may improve the usability of the satellite services by controlling the priority selection and the network transition timing for the plurality of public land mobile networks (PLMNs) on the legacy systems (e.g., LTE) where the satellite service time information is not explicitly transmitted.

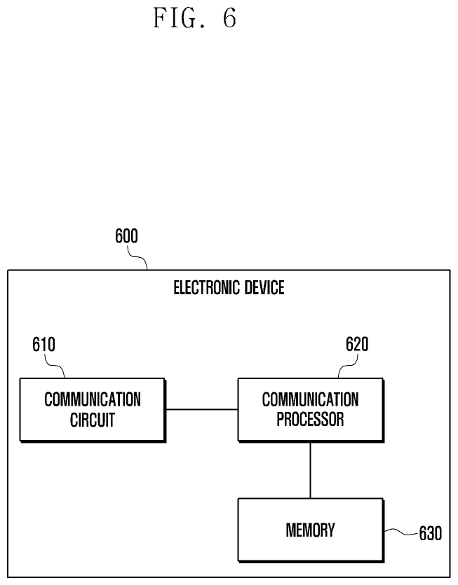

FIG. 6 is a block diagram illustrating an example configuration of the electronic device according to various embodiments.

Referring to FIG. 6, an electronic device 600 (e.g., the electronic device 101 of FIG. 1) according to an embodiment may include a communication circuit 610 (e.g., the wireless communication circuit 192 of FIG. 1), a communication processor (e.g., including processing circuitry) 420, and a memory 630 (e.g., the memory 130 of FIG. 1).

Some of the illustrated components may be omitted or replaced. The electronic device 600 may further include at least some of the components and/or functions of the electronic device 101 of FIG. 1. At least some of the components of the illustrated (or not illustrated) electronic device may be operatively, functionally, and/or electrically connected to each other.

According to an embodiment, a communication processor 620 may be operatively connected to the communication circuit 610. The communication processor 620 may include various processing circuitry and control the components of the electronic device 600. The communication processor 620 may include at least some of the components and/or functions of the processor 120 of FIG. 1. The detailed description of the processor 120 above applies equally to the communication processor 620 here, and as such may not be repeated here.

According to an embodiment, the computational and data processing functions that the communication processor 620 may implement on the electronic device 600 are not limited, but the features related to controlling the satellite service time will be described in detail below. The operations of the communication processor 620 may be performed by loading instructions stored in the memory 630.

According to an embodiment, the electronic device 600 includes one or more memories 630, and may include main memory and storage. The main memory may include volatile memory such as dynamic random access memory (DRAM), static RAM (SRAM), or synchronous dynamic RAM (SDRAM). The memory 630 may be a non-volatile memory and include a large-capacity storage device. The storage may include at least one of a one time programmable ROM (OTPROM), PROM, EPROM, EEPROM, mask ROM, flash ROM, flash memory, hard drive, or solid-state drive (SSD). The memory 630 may store various file data, and the stored file data may be updated according to the operation of the communication processor 620.

According to an embodiment, the communication circuit 610 may provide the electronic device 600 with communication with an external electronic device (e.g., the external electronic device 104 of FIG. 1) via at least one network (e.g., a legacy network or a 5G network). For example, the communication circuit 610 may support communication between the electronic device 600 and the external electronic device 104 via the satellite base station (e.g., the non-terrestrial wireless communication device 220 of FIG. 2) under the control of the communication processor 620.

According to an embodiment, the communication processor 620 may detect at least one satellite network based on the reception of at least one system information block (SIB), determine the service type provided by the at least one detected satellite network based on the satellite data stored in the memory 630, determine the priority of the detected public land mobile network (PLMN) based on the service type, determine, based on the satellite data stored in the memory 130, the service time of each of the plurality of non-terrestrial wireless communication devices (e.g., satellites) included in the PLMN selected based on the determined priority, and determine the priorities of the plurality of non-terrestrial wireless communication devices based on the determined service time. The satellite data may include, for example, at least one of MCC, MNC, TAI, cell ID, or information on the service type of the service provided by the satellite network. This is merely an example, and the satellite-related information included in the satellite data may vary depending on the configuration.

According to an embodiment, the communication processor 620 may search for at least one satellite network based on the at least one system information block (SIB) being searched, select the satellite network based on at least one of the public land mobile network (PLMN), target area identity (TAI), or cell ID, acquire the orbital information of the selected satellite network from the satellite data stored in the memory 130, and predict the service time of at least one non-terrestrial wireless communication device based on the orbital information of the satellite network. The orbital information may include information about an angle of a beam received through an antenna on the electronic device 600.

According to an embodiment, the communication processor 620 may determine whether the searched base station is a base station (e.g., a satellite base station) including the non-terrestrial wireless communication device based on whether a specific message corresponding to at least one of the public land mobile network (PLMN), the target area identity (TAI), or cell ID stored in the memory 130 or corresponding to the standard is used.

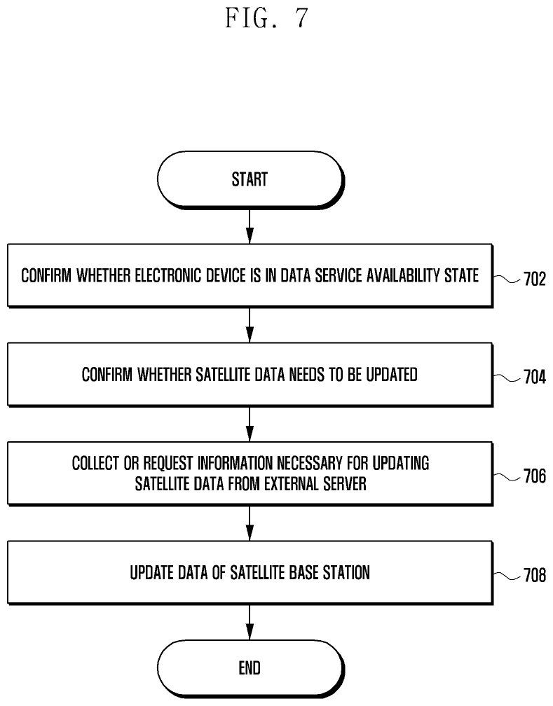

FIG. 7 is a flowchart illustrating an example process of updating satellite-related data in the electronic device according to various embodiments.

The operations described with reference to FIG. 7 may be implemented based on instructions that may be stored in a computer recording medium or memory (e.g., the memory 130 of FIG. 1). The method illustrated may be executed by the electronic device (e.g., electronic device 600 of FIG. 6) described above with reference to FIGS. 1 to 6, and the technical features described above may not be repeated here. The order of each operation of FIG. 7 may be changed, some operations may be omitted, and some operations may be performed simultaneously.

In operation 702 of FIG. 7, the communication processor (e.g., the communication processor 620 of FIG. 6) may confirm whether the electronic device 600 is in a data service availability state. The data service availability state may refer to a state in which the electronic device 600 is connected to any one of the non-terrestrial network or the terrestrial network. When the data service becomes available, the communication processor 620 may update a table including satellite data from an external server depending on whether the update time has elapsed or the PLMN corresponding to a new satellite has been detected. The new satellite may refer to the non-terrestrial wireless communication device (e.g., the non-terrestrial wireless communication device 220 of FIG. 2) with no previous connection record or search record.

In operation 704 of FIG. 7, the communication processor 620 may confirm whether the satellite data needs to be updated. The communication processor 620 may determine that the satellite data needs to be updated based on the elapsed specified time from the latest update timing of the satellite data. The communication processor 620 may determine that the satellite data needs to be updated based on the detection of a new satellite base station.

In operation 706 of FIG. 7, the communication processor 620 may collect information necessary for updating the satellite data or request the information from an external server. The communication processor 620 may generate identification information (e.g., a key) by combining any one of the PLMN, target area identity (TAI), and cell ID of a satellite requesting information. The identification information (e.g., the key) may be used to specify the satellite requesting the information. The communication processor 620 may transmit the generated satellite identification information to the external server to request data for the specified satellite.

In operation 708 of FIG. 7, the communication processor 620 may update data of a satellite base station (e.g., the satellite base station 524 of FIG. 5). The data of the satellite base station 524 may include, for example, at least one of an ID for the satellite base station 524, position information of the satellite base station 524, or satellite orbital information. The communication processor 620 may calculate the position and movement path of the satellite base station 524 based on the satellite orbital information, and determine the coverage of the satellite base station 524 based on the calculated position and movement path of the satellite base station 524. The communication processor 620 may calculate the position of the satellite base station 524 at specific timing using the position information of the satellite base station 524, and calculate the service time of the satellite base station 524 based on the position of the electronic device 600.

According to an embodiment, when the electronic device 600 detects the satellite network through the PLMN search, the electronic device 600 may use at least one combination of the PLMN and the target area identity (TAI) or the cell ID as the identification information (e.g., a key) to match the satellite information stored in the memory (e.g., the non-volatile memory) 130. The electronic device 600 may confirm the satellite information corresponding to the identification information and acquire information about the matching satellite from among the satellite information stored in the memory (e.g., the non-volatile memory) 130. The electronic device 600 may predict the service time of the satellite based on the satellite information stored in the memory 130.

According to an embodiment, the satellite information stored in the memory 130 may include feature values that may represent the satellite orbital information. The feature values may include, for example, antenna angle information of the beam for predicting the accurate satellite service coverage. The antenna angle information of the beam may include, for example, information about the angle of the beam received through the antenna.

The electronic device 600 may classify services provided by the corresponding satellite network according to the service type and pre-store the classified services. The service type may explicitly be received from the external server (e.g., a telecommunications operator server), or may be predefined on the electronic device 600 or updated based on the information received when the service type is actually registered in the corresponding satellite network. The service type information may be used to select the network registration priority in situations where the electronic device 600 detects the plurality of satellite networks.

Table 1 below illustrates examples of the satellite orbital information by the PLMN and TAI/cell ID stored in the electronic device 600.

TABLE 1

| | | | | | ServiceType | ephemeris |
|---|---|---|---|---|---|---|
| Index | MCC | MNC | TAI | CELL_ID | (bitmap) | information |
| 1 | 901 | 01 | 1 | 92 | 0000 1100 | 1 41167U |
| | | | | | | 15077B |
| 2 | 901 | 01 | 2 | 31 | 0010 0000 | 1 39227U |
| | | | | | | 13042A |
| 3 | 901 | 02 | * | * | 0000 1111 | 1 25544U |
| | | | | | | 98067A |
| 4 | 901 | 04 | 11 | 12 | 0000 0000 | EMPTY |

According to [Table 1], the electronic device 600 may store at least one of the pieces of information about the service type of the service provided by the MCC, MNC, TAI, cell ID, or satellite network in the memory 130.

TABLE 2
below shows the format of the service type

| Bit Position | 8, 7 | 6 | 5 | 4 | 3 | 2 | 1 |
|---|---|---|---|---|---|---|---|
| Service Type | Reserved | INTERNET | MMS | SMS | Call | Emergency | SMS |
| (capability) | | | | | | Call | (Emergency) |

The service type of the service provided by the satellite network may include, for example, at least one of reserved line service, internet, MMS, SMS, call, emergency call, or emergency SMS. According to an embodiment, the electronic device 600 may determine the registration priority of the plurality of satellite networks based on the kind or number of service types provided by the searched satellite network, under the control of the communication processor 620. The electronic device 600 may determine the registration priority of the plurality of detected PLMNs based on the service type.

According to an embodiment, the electronic device 600 may calculate the service time of the satellite network based on the satellite orbital information. The electronic device 600 may calculate the current position of the satellite using the position information of the satellite and determine the satellite coverage based on the current position of the electronic device 600. The electronic device 600 may calculate the service time of the satellite network based on the satellite coverage and the satellite orbital information.

According to an embodiment, the electronic device 600 may determine the priority of the plurality of PLMNs based on the calculated service time. For example, when a service time of a designated period (e.g., 60 seconds) is required to provide a voice service, the electronic device 600 may determine, among the plurality of PLMNs, the priority of PLMN having a service time exceeding the designated period to be relatively higher. On the other hand, the electronic device 600 may determine, among the plurality of PLMNs, the priority of PLMN having a service time below a designated period to be relatively low.

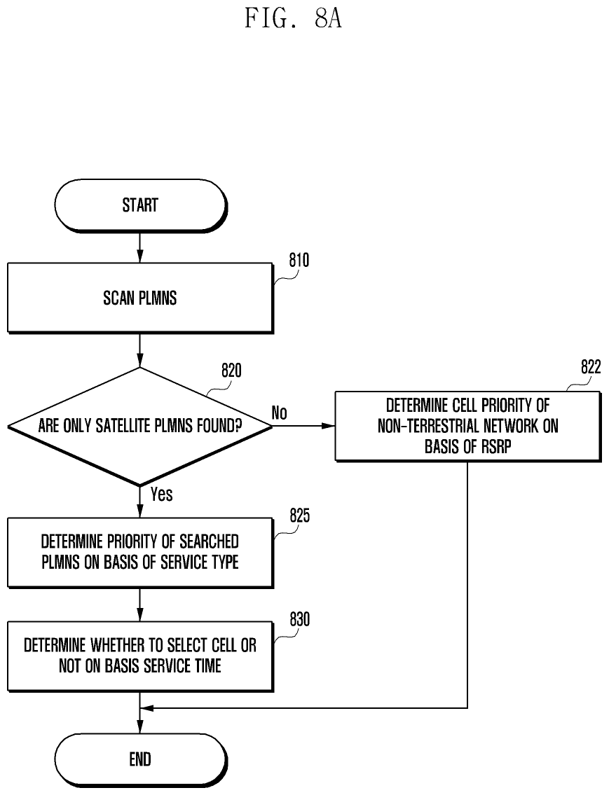

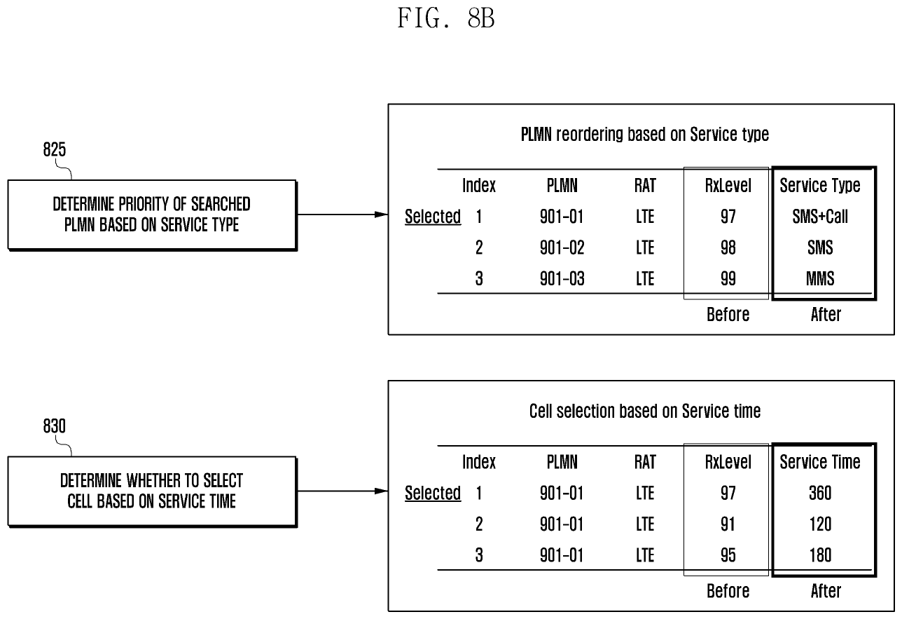

FIGS. 8A and 8B are a flowchart and diagram, respectively, illustrating an example process of determining the priority of PLMN and selecting cells using a service type and service time of the PLMN on the electronic device according to various embodiments.

The operations described with reference to FIGS. 8A and 8B may be implemented based on instructions that may be stored in a computer recording medium or memory (e.g., the memory 130 of FIG. 1). The method illustrated may be executed by the electronic device (e.g., electronic device 600 of FIG. 6) described above with reference to FIGS. 1 to 6, and the technical features described above may not be repeated here. The order of each operation of FIGS. 8A and 8B may be changed, some operations may be omitted, and some operations may be performed simultaneously.

In operation 810 of FIG. 8A, a communication processor (e.g., the communication processor 620 of FIG. 6) may scan the PLMN(s).

According to an embodiment, the electronic device 600 may scan the PLMN to detect the system information block (SIB) and at least one satellite network. The system information block (SIB) may include basic configurations for cellular networks around the electronic device 600. The electronic device 600 may establish a communication connection with the neighboring cellular networks using the SIB. There may be various types of SIBs, and each type may provide different information for each cell. The electronic device 600 may determine whether the searched PLMN is the satellite network based on the searched PLMN corresponding to at least one of the PLMN, cell ID, or target area identity (TAI) predefined in the memory 130. Alternatively, the electronic device 600 may determine whether the searched PLMN is the satellite network based on whether to use a specific message (e.g., MCC 9xx) specified in the standard.

In operation 820 of FIG. 8A, the communication processor 620 may confirm whether the satellite PLMN is searched during the PLMN scan process. Alternatively, the communication processor 620 may confirm whether a terrestrial PLMN is also searched. The communication processor 620 may perform operation 822 or operation 825 based on whether the satellite PLMN and/or the terrestrial PLMN is searched.

In operation 822 of FIG. 8A, the communication processor 620 may determine the priority of the cells within the PLMN based on the RSRP when the terrestrial PLMN is searched (operation 820—No). The communication processor 620 may determine a PLMN to perform a communication connection based on a preconfigured priority of the PLMN. For example, when the PLMNs corresponding to both the satellite network and terrestrial network are searched together, the communication processor 620 may exclude the PLMN corresponding to the satellite network from the priority and determine the priority of the PLMNs corresponding to the terrestrial network based on the received signal strength (e.g., RSRP).

In operation 825 of FIG. 8A, the communication processor 620 may determine the priority of the PLMN searched based on the service type when only the satellite PLMN is searched (operation 820—Yes). The service type may explicitly be received from the external server (e.g., a telecommunications operator server), or may be predefined on the electronic device 600 or updated based on the information received when the service type is actually registered in the corresponding satellite network. The service type information may be used to select the network registration priority in situations where the electronic device 600 detects the plurality of satellite networks.

As described in FIG. 8B, the communication processor 620 may determine the priority based on the service type of the searched PLMN. For example, the communication processor 620 may determine the PLMN supporting the largest number of service types as the highest priority. Alternatively, the communication processor 620 may select a PLMN to be registered based on a service (e.g., a service most frequently used by the user) appropriate for the user in a situation where the number of supported service types is matched.

For example, when the service type provided on a searched first PLMN 901-01 is SMS and call, and a service type provided on a second PLMN 901-02 is SMS, the communication processor 620 may determine the priority of the first PLMN 901-01 having the larger number of provided service types to be higher than that of the second PLMN 901-02.

As described in FIG. 5, the satellite base stations are relatively far from each terminal, so the change in RSRP strength due to the change in distance between the base station and each terminal may be small. Therefore, it may be difficult to perform RSRP-based reselection or handover (HO) as in the existing terrestrial networks. Even when the received signal strength (Rx level) of the searched first PLMN 901-01 is relatively lower than that of the second PLMN 901-02, the communication processor 620 may determine the priority of the first PLMN 901-01 providing a larger number of service types to be higher than that of the second PLMN 901-02.

According to an embodiment, the communication processor 620 may determine the priority of the PLMN supporting the largest number of service types as highest priority, regardless of the received signal strength (Rx level).

According to an embodiment, the communication processor 620 may preferentially select PLMNs whose received signal strength (Rx level) satisfies the designated level, and determine, among the selected PLMNs, the PLMN supporting the largest number of service types as the highest priority, regardless of the received signal strength (Rx level). This is because, when the received signal strength (Rx level) is small below the designated level, the smooth communication connection with the electronic device 600 may be difficult even if the number of service types provided is large.

In operation 830 of FIG. 8A, the communication processor 620 may determine whether to select a cell based on the service time.

According to an embodiment, the communication processor 620 may select a PLMN for establishing a communication connection based on the priority. The selected PLMN may include a plurality of satellite networks. The communication processor 620 may generate the identification information (e.g., the key) that specifies a satellite requesting information by combining any one of the PLMN, target area identity (TAI), and cell ID. The communication processor 620 may transmit the generated satellite identification information to the external server to request the data (e.g., satellite orbital information) for the specified satellite.

According to an embodiment, the communication processor 620 may calculate the service time of the satellite network based on the satellite orbital information. The communication processor 620 may calculate the current satellite position using the satellite position information and determine the satellite coverage (e.g., the non-terrestrial wireless communication device 220 of FIG. 2) included in the satellite network based on the current position of the electronic device 600. The communication processor 620 may calculate the service time of the satellite network based on the satellite coverage and the satellite orbital information.

According to an embodiment, the communication processor 620 may determine the service time based on the satellite coverage and the satellite orbital information, and may determine cell-specific priority based on the service time.

According to an embodiment, a plurality of cells are configured to form a network. A cell may be responsible for communication with an electronic device 600 in a designated area. The network may organize the cells and have coverage over a relatively wider area than the cells.

For example, in operation 825, the communication processor 620 may select the first PLMN 901-01 based on the service type supported by the satellite network. The first PLMN 901-01 may include a plurality of cells. Each cell may have different coverage depending on an area that each cell covers, and the relative position of each cell with respect to the satellite base station may also vary. The communication processor 620 may compare the service time of each cell and determine to establish a communication connection by selecting a first cell with the longest service time.

According to an embodiment, the communication processor 620 may preferentially select cells whose received signal strength (Rx level) satisfies the designated level, and determine, among the selected cells, the cell supporting the longest service time as the highest priority, regardless of the received signal strength (Rx level). This is because, when the received signal strength (Rx level) is small below the designated level, the smooth communication connection with the electronic device 600 may be difficult even if the service time provided is long.

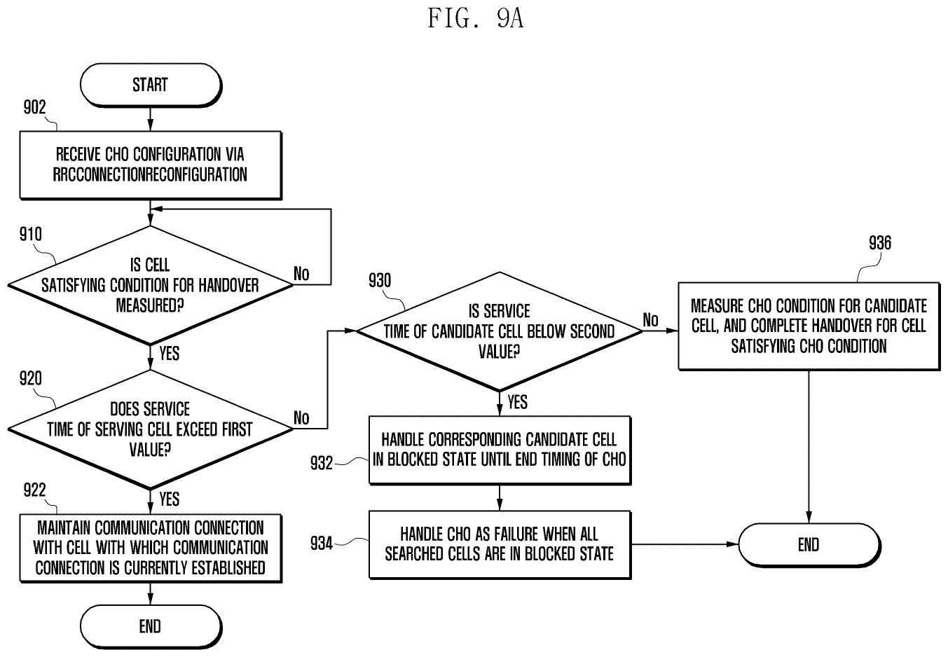

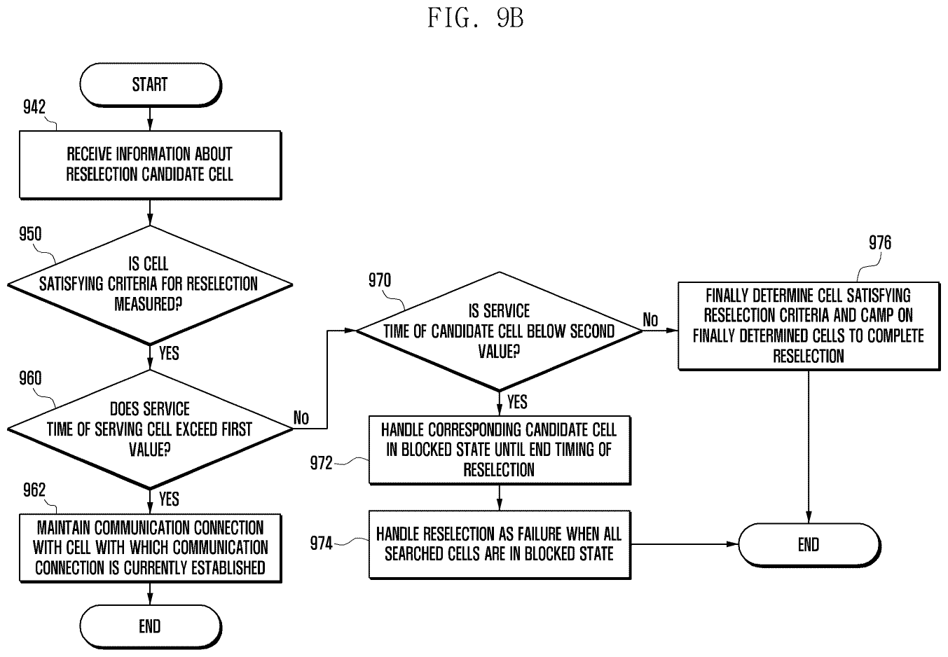

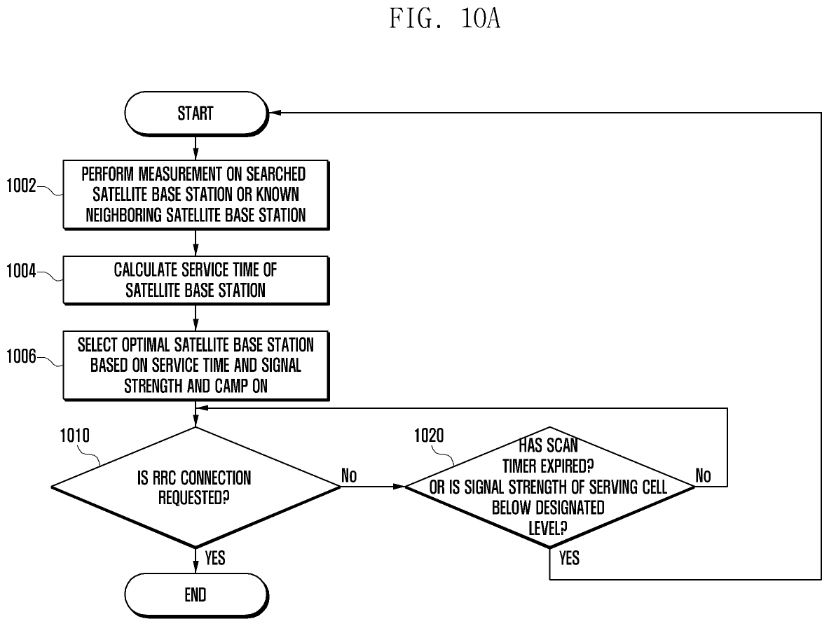

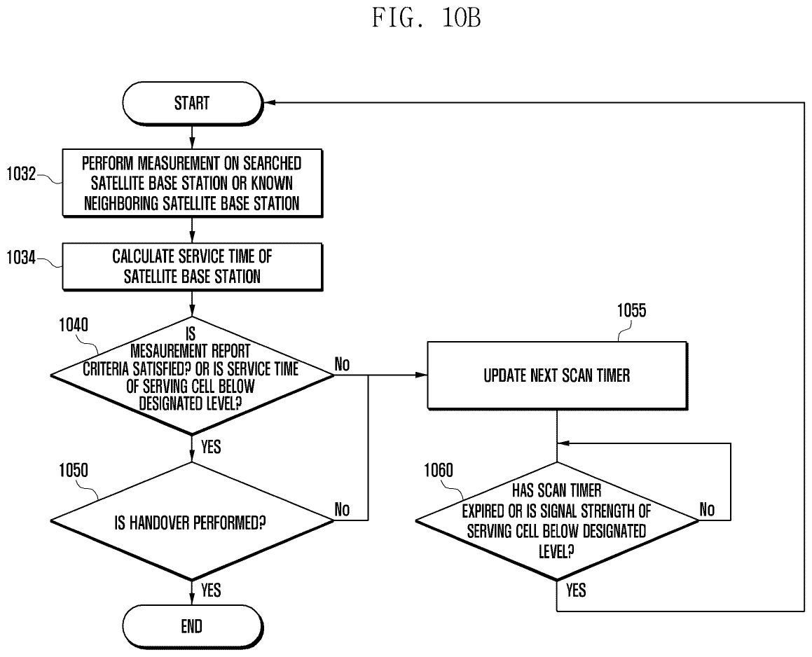

According to an embodiment, the communication processor 620 may select a cell to establish the communication connection based on the cell priority. The operation of the communication processor 620 selecting a cell or performing a handover based on the service time will be described in greater detail below with reference to FIGS. 9A and 10B. The handover (HO) may refer to an operation in which the electronic device 600 moves to another candidate cell to establish the communication connection while being in communication-connected state to a serving cell. As described in FIG. 8B, the communication processor 620 may re-determine the priority of a plurality of cells included in the PLMN having the highest priority based on the service time. The communication processor 620 may select the cell having the highest priority to establish the communication connection.

According to an embodiment, the communication processor 620 may determine not to establish the communication connection with a cell whose received signal strength is below a certain level, regardless of the service time.

According to an embodiment, the electronic device 600 may acquire the service type and time for a discovered satellite network and utilize the acquired service type and time to optimally select a satellite network. For example, the electronic device 600 may detect a satellite network in a loss coverage state. The electronic device 600 may determine the priority of the detected PLMN based on the service type. The electronic device 600 may perform, based on the service time, the cell selection for the PLMN selected based on the priority.

Operation 825 for the service type is not essential, and only operation 830 for service time may be performed by the electronic device 600. The order of each operation of FIGS. 8A and 8B may be changed, some operations may be omitted, and some operations may be performed simultaneously.

According to an embodiment, operations 825 and 830 do not necessarily need to be performed sequentially. The electronic device 600 may determine priority based on the service time when the service types are the same or when the service type may not be specified.

According to an embodiment, operation 825 may be omitted, and the electronic device 600 may determine whether to select a cell using the service time based on operation 830.

FIG. 9A is a flowchart illustrating an example process of performing a handover on the electronic device according to various embodiments.

FIG. 9B is a flowchart illustrating an example process of performing reselection on the electronic device according to various embodiments.

The operations described with reference to FIGS. 9A and 9B may be implemented based on instructions that may be stored in a computer recording medium or memory (e.g., the memory 130 of FIG. 1). The method illustrated may be executed by the electronic device (e.g., electronic device 600 of FIG. 6) described above with reference to FIGS. 1 to 6, and the technical features described above may not be repeated here. The order of each operation of FIGS. 9A and 9B may be changed, some operations may be omitted, and some operations may be performed simultaneously.

In operation 902 of FIG. 9A, the communication processor (e.g., the communication processor 620 of FIG. 6) may receive a conditional handover (CHO) configuration via RRCconnectionReconfiguration. The communication processor 620 may acquire information about cells that are candidates for handover and information about conditions (e.g., HO trigger condition) under which the handover is executed.

In operation 910 of FIG. 9A, the communication processor 620 may confirm whether a cell satisfying the conditions for the handover is measured. The communication processor 620 may continue searching until a cell satisfying the conditions (e.g., the HO trigger condition) under which the handover (HO) is executed is measured.

The conditions under which the handover is executed will be described in operations 920 and 930 below.

In operation 920 of FIG. 9A, the communication processor 620 may determine whether the service time of the serving cell exceeds a first value. The first value may refer to a preparation time for network mobility. The first value may vary depending on the configuration.

According to an embodiment, based on the service time of the serving cell exceeding the first value (operation 920—Yes), the communication processor 620 may maintain the communication connection with the cell with which the communication connection is currently established in operation 922. The serving cell may refer to the cell with which the communication connection is established with the electronic device 600. The cells that have not established the communication connection with the electronic device 600 are cells that are waiting to establish the communication connection with the electronic device 600 and may be referred to as “candidate cells.” When the service time of the serving cell exceeds the first value, there may be sufficient time for the serving cell to provide the communication services to the electronic device 600. Therefore, the electronic device 600 may maintain the communication connection with the serving cell rather than moving to another candidate cell when the service time of the serving cell exceeds the first value.

According to an embodiment, the communication processor 620 may complete the conditional handover (CHO) when the service time is less than the first value or the service time of the candidate cell is greater than the second value.

According to an embodiment, the electronic device 600 may calculate the current position of the satellite using the position information of the satellite and determine the satellite coverage based on the current position of the electronic device 600. The electronic device 600 may calculate the service time of the satellite network and the cells included in the satellite network based on the satellite coverage and the satellite orbital information.

In operation 930 of FIG. 9A, the communication processor 620 may determine whether the service times of other candidate cells other than the serving cell are below a second value based on the service time of the serving cell being below the first value (operation 920—No). The second value may refer to a minimum service time value for users using the satellite. The second value may refer to the minimum service time required for the satellite base station to provide satellite services. The second value may vary depending on the configuration.

According to an embodiment, based on the service times of the candidate cells being below the second value (operation 930—Yes), in operation 932, the communication processor 620 may handle the corresponding candidate cell in the restricted (e.g., blocked) state until the end timing of the conditional handover (CHO). The CHO is a conditional handover, and may refer to an operation of performing the handover in the situation where specific conditions are satisfied. Candidate cells having the service time less than the second value may have insufficient time to provide the satellite services even if the communication connection is established through the electronic device 600. The electronic device 600 may exclude candidate cells that lack sufficient time to provide satellite services from a candidate group by processing the candidate cells in a restricted (e.g., block) state.

In operation 934 of FIG. 9A, the communication processor 620 may handle the CHO as a failure when all the searched cells are in the restricted (e.g., block) state. The communication processor 620 may repeat the measurement operation for the CHO when at least one of the searched cells is not in the restricted (e.g., block) state.

In operation 936 of FIG. 9A, the communication processor 620 may measure the CHO condition for the candidate cells based on the service times of the candidate cells exceeding the second value (operation 930—No), and may complete the handover for the cell satisfying the CHO condition. The communication processor 620 may configure the cell satisfying the CHO condition as a target cell and transmit a specific message (e.g., RRC ConnectionReconfiguration Complete) to complete the handover. The communication processor 620 may complete the CHO based on the service time of the serving cell being below (or less than or equal to) the first value and the service times of the candidate cells exceeding (or greater than or equal to) the second value.

According to an embodiment, the communication processor 620 may maintain the communication connection with the cell with which the communication connection is currently established based on the service time of the serving cell exceeding the first value, measure the service times of the candidate cells based on the service time of the serving cell being below the first value, camp on cells whose service time satisfy the designated level, exclude candidate cells whose the service time is below the second value from the candidate cells for handover until the reselection end timing, and determine that the reselection has failed when all candidate cells are excluded.

The electronic device according to the disclosure may add the service time as a separate condition in the conditional handover (CHO) process that is capable of determining HO timing. The electronic device according to the disclosure may provide relatively improved usability by delaying or preventing the handover depending on whether the service time is satisfied, even when the CHO condition is satisfied, as compared to the case where the service time is not utilized.

In operation 942 of FIG. 9B, the communication processor (e.g., the communication processor 620 of FIG. 6) may receive information about candidate cells for reselection. The cell reselection may refer to an operation in which the electronic device 600 in the idle state selects a cell to establish the communication connection. The idle state may refer to a state in which the electronic device 600 has not established a communication connection with another cell. The handover (HO) may refer to an operation in which the electronic device 600 moves to another candidate cell to establish the communication connection while being in a communication-connected to a serving cell.

In operation 950 of FIG. 9B, the communication processor 620 may confirm whether a cell satisfying the criteria for reselection is measured. The communication processor 620 may continue searching until the cell satisfying the criteria for reselection is measured. The criteria for reselection will be described in operations 960 and 970 below.

In operation 960 of FIG. 9B, the communication processor 620 may determine whether the service time of the serving cell exceeds the first value. The first value may refer to a preparation time for network mobility. Based on the service time of the serving cell exceeding the first value (operation 960—Yes), the communication processor 620 may maintain the communication connection with the cell with which the communication connection is currently established in operation 962.

In operation 970 of FIG. 9B, the communication processor 620 may determine whether the service times of other candidate cells other than the serving cell are below a second value based on the service time of the serving cell being below the first value (operation 960—No). The second value is the minimum service time for users using a satellite, and may vary depending on the configuration. The second value may refer to the minimum service time required to provide the satellite services. Based on the service times of the candidate cells being below the second value (operation 970—Yes), in operation 972, the communication processor 620 may handle the corresponding candidate cell in the restricted (e.g., blocked) state until the end timing of the reselection.

In operation 974 of FIG. 9B, the communication processor 620 may handle the reselection as a failure when all the searched cells are in the blocked state.

In operation 976 of FIG. 9B, the communication processor 620 may finally determine the cell satisfying the reselection criteria among the candidate cells based on the service times of the candidate cells exceeding the second value (operation 970—No), and may camp on the finally determined cell to complete the reselection.

The handover (HO) may refer to an operation in which the electronic device 600 moves a cell while being in the communication-connected state to another cell. On the other hand, the cell reselection may refer to an operation in which the electronic device 600 in the idle state moves a cell. The idle state may refer to a state in which the communication connection with another cell has not been established.

According to an embodiment, the connected state and the idle state may be classified according to the RRC state, and the measurement performing process may also vary depending on the RRC state. The operation in which the measurement performing process changes depending on the RRC state will be described in greater detail below with reference to FIGS. 10A and 10B.

FIG. 10A is a flowchart illustrating an example in which service time-based measurement is performed in an idle state of the electronic device according to various embodiments.

FIG. 10B is a flowchart illustrating an example in which the service time-based measurement is performed in a connected state of the electronic device according to various embodiments.

The operations described with reference to FIGS. 10A and 10B may be implemented based on instructions that may be stored in a computer recording medium or memory (e.g., the memory 130 of FIG. 1). The method illustrated may be executed by the electronic device (e.g., electronic device 600 of FIG. 6) described above with reference to FIGS. 1 to 6, and the technical features described above may not be repeated here. The order of each operation of FIGS. 10A and 10B may be changed, some operations may be omitted, and some operations may be performed simultaneously.

In operation 1002 of FIG. 10A, a communication processor (e.g., the communication processor 620 of FIG. 6) may perform a measurement on the searched non-terrestrial wireless communication device (e.g., the satellite base station or the known neighboring satellite base stations) (e.g., the non-terrestrial wireless communication device 220 of FIG. 2). The measurement may refer to an operation in which the electronic device 600 evaluates the reception signal quality of candidate cells other than the serving cell. The electronic device 600 may select an optimal cell or switch a cell with which the communication connection is established through the measurement. The electronic device 600 may determine conditions (e.g., data rate, delay, coverage, service time) of a plurality of candidate cells through the measurement of the candidate cells and perform the conditional handover (CHO).

In operation 1004 of FIG. 10A, the communication processor 620 may calculate the service time of the satellite base station. The communication processor 620 may calculate the service time of the non-terrestrial wireless communication device (e.g., the satellite base station) 220 based on the satellite orbital information. The communication processor 620 may calculate the current position of the satellite using the position information of the satellite and determine the coverage of the satellite base station based on the current position of the electronic device 600. The communication processor 620 may calculate the service time of the satellite base station based on the coverage of the satellite base station and the satellite orbital information.

In operation 1006 of FIG. 10A, the communication processor 620 may select an optimal satellite base station based on the service time and the signal strength and camp on the selected optimal satellite base station. The camp on may refer to a state in which the electronic device 600 is connected to a specific cell or a specific base station and remains in a waiting state. The communication processor 620 may camp on the specific candidate cell to prepare for the handover from the serving cell to another candidate cell before performing the handover.

In operation 1010 of FIG. 10A, the communication processor 620 may confirm whether the RRC connection has been requested. Based on whether the RRC connection has been requested (operation 1010—Yes), the communication processor 620 may change the idle state of the electronic device 600 to the connected state and terminate the operation. The idle state may refer to a state in which the electronic device 600 has not established a communication connection with another cell. Based on whether the RRC connection has been requested, the communication processor 620 may establish the communication connection with the candidate cells on which the camp on has been performed.

In operation 1020 of FIG. 10A, based on the RRC connection not having been requested (operation 1010—No), the communication processor 620 may confirm whether a scan timer has expired or the signal strength of the serving cell is below the designated level. The scan time may refer to a time interval during which the electronic device 600 searches for or monitors other neighboring cells. The electronic device 600 may periodically search for neighboring cells or monitor the signal strength of the searched neighboring cells using the scan timer.

According to an embodiment, the communication processor 620 may perform the measurement on the searched satellite base station or the known neighboring satellite base stations again in operation 1002 based on the scan timer having expired or the signal strength of the serving cell being below the designated level (operation 1020—Yes). The measurement may refer to an operation in which the electronic device 600 evaluates the reception signal quality of candidate cells other than the serving cell.

According to an embodiment, the communication processor 620 may perform the monitoring and measurement on the serving satellite in the idle state after camping on the serving cell based on the scan timer not having expired and the signal strength of the serving cell exceeding the designated level (operation 1020—No). Thereafter, it may be confirmed again in operation 1010 whether the RRC connection has been requested.

According to an embodiment, the communication processor 620 may perform the measurement on the satellite base station being searched or the neighboring satellite base stations with the previously searched history in a state (idle state) in which the electronic device 600 is not connected to a cell, select an optimal cell based on the service time and the signal strength, camp on the selected optimal cell, and change the electronic device in the idle state to the connected state based on the RRC connection having been requested.

According to an embodiment, the communication processor 620 may confirm whether the scan timer has expired or the signal strength of the serving cell is below the designated level based on the RRC connection not having been requested, and perform the measurement on the searched satellite base station or the neighboring satellite base stations with the previously searched history based on the scan timer having expired or the signal strength of the serving cell being below the designated level.

According to an embodiment, the communication processor 620 may confirm whether the scan timer has expired or the signal strength of the serving cell is below the designated level based on the RRC connection not having been requested, and may re-confirm whether the RRC connection has been requested based on the scan timer not having expired and the signal strength of the serving cell exceeding the designated level.

In operation 1032 of FIG. 10B, the communication processor (e.g., the communication processor 620 of FIG. 6) may perform the measurement on the searched satellite base station or the known neighboring satellite base stations. Operation 1032 may be performed in a state in which the electronic device 600 is connected to a cell. Unlike the idle state, the connected state to the cell may be a state in which the electronic device 600 communicates with the base station.

In operation 1034 of FIG. 10B, the communication processor 620 may calculate the service time of the satellite base station. The communication processor 620 may calculate the service time of the non-terrestrial wireless communication device (e.g., the satellite base station) 220 based on the satellite orbital information. The communication processor 620 may calculate the current position of the satellite using the position information of the satellite and determine the coverage of the satellite base station based on the current position of the electronic device 600. The communication processor 620 may calculate the service time of the satellite base station based on the coverage of the satellite base station and the satellite orbital information.

In operation 1040 of FIG. 10B, the communication processor 620 may confirm whether criteria for a measurement report are satisfied or whether the service time of the serving cell is below the designated level. The measurement report may include any one of signal strength, frequency, moving speed of the electronic device 600, position of the electronic device 600, or cell identification information of other candidate cells searched in addition to the serving cell. The criteria for the measurement report may be the same as or partially different from the cellular-based measurement report criteria. For example, the values of the measurement report may include reference signal received power (RSRP), reference signal received quality (RSRQ), signal-to-noise interference ratio (SINR), carrier to interference and noise ratio (CINR), and layer-1 (L1)-RSRP that are measured on the electronic device 600. This is only an example, and the values of the measurement report may vary depending on the configuration. The reported values may be reported in the form of direct numerical values or index values corresponding to the values.

In operation 1050 of FIG. 10B, the communication processor 620 may confirm whether to perform the handover based on the criteria for the measurement report being satisfied or the service time of the serving cell being below the designated level (operation 1040—Yes).

According to an embodiment, the communication processor 620 may terminate the operations illustrated in FIG. 10B based on the handover being performed.

In operation 1055 of FIG. 10B, the communication processor 620 may update the next scan timer based on the criteria for the measurement report not being satisfied and the service time of the serving cell exceeding the designated level (operation 1040—No).

The communication processor 620 may update the next scan timer based on the handover not being performed even if the criteria for the measurement report are satisfied or the service time of the serving cell is below the designated level (operation 1050—No).

In operation 1060 of FIG. 10B, the communication processor 620 may confirm whether the scan timer has expired or whether the signal strength of the serving cell is below the designated level.

The communication processor 620 may repeat operation 1060 based on the scan timer not having expired and the signal strength of the serving cell exceeding the designated level.

According to an embodiment, the communication processor 620 may perform the measurement on the searched satellite base station or the known neighboring satellite base stations again in operation 1032 based on the scan timer having expired or the signal strength of the serving cell being below the designated level (operation 1060—Yes).

According to an embodiment, the communication processor 620 may perform the measurement on the satellite base station that is searched for or the neighboring satellite base stations with the previously searched history while the electronic device 600 is connected to a cell, calculate the service time of the satellite base station, confirm whether the criteria for the measurement report are satisfied or the service time of the serving cell is below the designated level, and perform the handover based on the criteria for the measurement report being satisfied or the service time of the serving cell being below the designated level.

According to an embodiment, the communication processor 620 may update the next scan timer based on the criteria for the measurement report not being satisfied and the service time of the serving cell exceeding the designated level. Alternatively, the communication processor 620 may update the next scan timer based on the handover not being performed even if the criteria for the measurement report are satisfied or the service time of the serving cell is below the designated level.

According to an embodiment, the communication processor 620 may confirm whether the scan timer has expired or whether the signal strength of the serving cell is below the designated level based on the scan timer not having expired and the signal strength of the serving cell exceeding the designated level, and may perform the measurement on the satellite base station being searched or the neighboring satellite base stations with the previously searched history based on the scan timer having expired or the signal strength of the serving cell being below the designated level.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
at least one communication processor comprising processing circuitry; and
a memory,
wherein at least one communication processor, individually and/or collectively, is configured to cause the electronic device to:
detect at least one satellite network based on a reception of at least one system information block (SIB),
generate a public land mobile network (PLMN) list including at least one PLMN,
determine a service time of each of a plurality of non-terrestrial wireless communication devices included in the PLMN list based on satellite data stored in the memory, and
determine priorities of the plurality of non-terrestrial wireless communication devices based on the determined service time, and
wherein the satellite data includes at least one of a mobile country code (MCC), a mobile network code (MNC), a mobile network code (TAI), a cell ID, and/or information about a service type of a service provided by the satellite network.

2. The electronic device of claim 1, wherein at least one communication processor, individually and/or collectively, is configured to cause the electronic device to: search for at least one satellite network based on the at least one system information block (SIB) being searched,
select the satellite network based on at least one of the public land mobile network (PLMN), target area identity (TAI), and/or cell ID, acquire orbital information of the selected satellite network from the satellite data stored in the memory, and
predict the service time of the at least one non-terrestrial wireless communication device based on the orbital information of the satellite network, and
wherein the orbital information includes information about an angle of a beam received through an antenna on the electronic device.

3. The electronic device of claim 1, wherein at least one communication processor, individually and/or collectively, is configured to cause the electronic device to: determine the service type provided by the at least one detected satellite network based on the satellite data stored in the memory, or
receive the information about the service type of the satellite network from an external server and store the information in the memory, and
update the satellite data stored in the memory based on satellite-related information received based on registering with the satellite network.

4. The electronic device of claim 3, wherein at least one communication processor, individually and/or collectively, is configured to cause the electronic device to determine a registration priority of the plurality of detected PLMNs based on the service type.

5. The electronic device of claim 4, wherein the service type includes at least one of reserved line service, internet, MMS, SMS, call, emergency call, and/or emergency SMS, and
at least one communication processor, individually and/or collectively, is configured to cause the electronic device to determine the registration priority of the plurality of detected PLMNs based on the kind and/or number of service types provided by the searched satellite network.

6. The electronic device of claim 1, wherein at least one communication processor, individually and/or collectively, is configured to cause the electronic device to update a table including the satellite data from the external server based on a specified update time having elapsed or the detection of the PLMN including the non-terrestrial wireless communication device with no previous connection record or search record.

7. The electronic device of claim 1, wherein at least one communication processor, individually and/or collectively, is configured to cause the electronic device to determine whether the searched base station is a base station including the non-terrestrial wireless communication device based on whether a specific message corresponding to at least one of the public land mobile network (PLMN), target area identity (TAI), and/or cell ID stored in the memory and/or corresponding to a standard is used.

8. The electronic device of claim 1, wherein at least one communication processor, individually and/or collectively, is configured to cause the electronic device to: determine the priority of the detected PLMN based on the service type, and
determine a cell with the highest service time among a plurality of cells included in the PLMN with the highest priority, and perform cell selection.

9. The electronic device of claim 8, wherein at least one communication processor, individually and/or collectively, is configured to cause the electronic device to exclude a cell with received signal strength below the designated level from candidate cells for the cell selection.

10. The electronic device of claim 1, wherein at least one communication processor, individually and/or collectively, is configured to cause the electronic device to: acquire information about a candidate cell for handover and information about a condition under which the handover is executed,
confirm whether a cell satisfying the condition for the handover is measured, and perform the handover, and
wherein the condition for the handover includes a condition for the service time of the serving cell and service times of candidate cells.

11. The electronic device of claim 10, wherein at least one communication processor, individually and/or collectively, is configured to cause the electronic device to: maintain a communication connection with a cell with which the communication connection is currently established based on the service time of the serving cell exceeding a first value,
measure the service times of the candidate cells based on the service time of the serving cell being below the first value, and perform a handover for a cell whose service time satisfies the designated level,
exclude candidate cells whose service time is below second value from the candidate cells for the handover until end timing of a conditional handover (CHO), and
determine that the handover has failed based on all the candidate cells being excluded,
wherein, the first value includes a preparation time for network mobility, and
the second value includes a minimum service time required to provide a satellite service.

12. The electronic device of claim 10, wherein at least one communication processor, individually and/or collectively, is configured to cause the electronic device to complete the handover by transmitting a message to a cell for the handover.

13. The electronic device of claim 1, wherein at least one communication processor, individually and/or collectively, is configured to: receive information about candidate cells for reselection, and acquire information about criteria for performing the reselection, and
confirm whether a cell satisfying criteria for reselection is measured, and camp on the confirmed cell, and
wherein the criteria for the reselection includes a condition for the service time of the serving cell and service times of candidate cells.

14. The electronic device of claim 13, wherein at least one communication processor, individually and/or collectively, is configured to cause the electronic device to:
maintain a communication connection with a cell with which the communication connection is currently established based on the service time of the serving cell exceeding a first value, measure the service times of the candidate cells based on the service time of the serving cell being below the first value, and camps on the cell whose service time satisfies the designated level,
exclude a candidate cell whose service time is below a second value from the candidate cells for handover until end timing of reselection, and
determine that the reselection has failed based on all the candidate cells being excluded,
wherein the first value includes a preparation time for network mobility, and
the second value includes a minimum service time required to provide a satellite service.

15. The electronic device of claim 1, wherein at least one communication processor, individually and/or collectively, causes the electronic device to: perform measurement on a satellite base station being searched or neighboring satellite base stations with previously searched history in a state (idle state) in which the electronic device is not connected to the cell,
select an optimal cell based on the service time and signal strength and camps on the selected optimal cell, and
change the electronic device in the idle state to the connected state based on an RRC connection having been requested.

16. The electronic device of claim 15, wherein at least one communication processor, individually and/or collectively, is configured to cause the electronic device to: confirm whether a scan timer has expired or the signal strength of the serving cell is below a designated level based on the RRC connection not having been requested, and
perform measurements on a satellite base station being searched and/or the neighboring satellite base stations with the previously searched history based on the scan timer having expired or the signal strength of the serving cell being below the designated level.

17. The electronic device of claim 15, wherein at least one communication processor, individually and/or collectively, is configured to cause the electronic device to: confirm whether a scan timer has expired or the signal strength of the serving cell is below a designated level based on the RRC connection not having been requested, and
re-confirm whether the RRC connection has been requested based on the scan timer not having expired and the signal strength of the serving cell exceeding the designated level.

18. The electronic device of claim 1, wherein at least one communication processor, individually and/or collectively, is configured to cause the electronic device to: perform measurement on a satellite base station being searched or neighboring satellite base stations with previously searched history in a state in which the electronic device is connected to the cell,
calculate the service time of the satellite base station,
confirm whether criteria for a measurement report are satisfied or whether the service time of the serving cell is below the designated level, and
perform a handover based on the criteria for the measurement report being satisfied or the service time of the serving cell being below the designated level.

19. The electronic device of claim 18, wherein at least one communication processor, individually and/or collectively, is configured to cause the electronic device to: update a next scan timer based on the criteria for the measurement report not being satisfied and the service time of the serving cell exceeding the designated level, and
update the next scan timer based on the handover not being performed even if the criteria for the measurement report are satisfied or the service time of the serving cell is below the designated level.

20. The electronic device of claim 19, wherein at least one communication processor, individually and/or collectively, is configured to cause the electronic device to confirm whether the scan timer has expired or whether the signal strength of the serving cell is below the designated level based on the scan timer not having expired and the signal strength of the serving cell exceeding the designated level, and
perform measurements on the satellite base station being searched or the neighboring satellite base stations with the previously searched history based on the scan timer having expired or the signal strength of the serving cell being below the designated level.
